(19) United States
(12) Patent Application Publication
(10) Pub. No.: US 2025/0140070 A1
(43) Pub. Date: May 1, 2025

(54) ELECTRONIC GAMING OPERATIONS HAVING MULTIPLE ROUNDS OF FEATURE GAMES WHEN TRIGGERED

(71) Applicant: Aristocrat Technologies, Inc., Las Vegas, NV (US)

(72) Inventors: Jeffrey Uss, Reno, NV (US); Kevin Walsh, Reno, NV (US); David Marsh, Charlottesville, VA (US); Joseph Lambert, Atlanta, GA (US); Daniel Marston, Reno, NV (US); Zachary Cooper, Reno, NV (US); Timothy Schelz, Las Vegas, NV (US)

(21) Appl. No.: 18/813,685

(22) Filed: Aug. 23, 2024

Related U.S. Application Data
(60) Provisional application No. 63/594,330, filed on Oct. 30, 2023.

(51) Int. Cl. G07F 17/32; G07F 17/34

(52) U.S. Cl. CPC G07F 17/3267; G07F 17/34

(57) ABSTRACT

An electronic gaming system is provided. The electronic gaming system may be configured to, in response to receiving a user input, determine that at least one winning pattern is included on a base game bingo card by electronically comparing a base game ball call to the base game bingo card, cause a base game reel outcome to be displayed on a display including a set of reels, the base game reel outcome corresponding to the at least one winning pattern, determine that a feature game is triggered, in response to the feature game being triggered, and determine that at least one new winning pattern is included (i) on a new bingo card by electronically evaluating the new bingo card using the base game ball call or (ii) on the base game bingo card by electronically evaluating the base game bingo card using a new ball call.

### CROSS-REFERENCE TO RELATED APPLICATIONS

This application claims the benefit of priority of U.S. Provisional Patent Application No. 63/594,330, filed Oct. 30, 2023, and entitled “ELECTRONIC GAMING OPERATIONS HAVING MULTIPLE ROUNDS OF FEATURE GAMES WHEN TRIGGERED,” the contents and disclosures of which are hereby incorporated by reference in their entirety.

### TECHNICAL FIELD

The field of disclosure relates generally to electronic gaming, and more specifically, to electronic gaming operations that include an electronic gaming device configured to trigger one or more rounds of feature games from a single instance of a base game to extend game play and provide increased variability within the game.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her credit input to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random. In one aspect, an electronic gaming device includes a user interface comprising a display, a memory storing gaming instructions, and a game controller comprising at least one processor in communication with the memory and the user interface, where the game controller is configured to execute the gaming instructions to receive an initial credit input, initiate a game instance in response to receiving the initial credit input, and in response to a completion of the game instance, trigger a bonus game operation that extends the game instance. Associated processes may be responsive to or otherwise based off of an initial credit input at a time without requiring the player to re-wager. As such, the bonus operation may be automatically triggered at a point at which play would otherwise end without another credit input or other action by the player to continue the game session. An example embodiment of the subject matter disclosed will now be described with reference to the accompanying drawings.

### BRIEF DESCRIPTION

In one aspect, an electronic gaming system is provided. The electronic gaming system may include at least one memory with instructions stored thereon and at least one processor in communication with the at least one memory. The instructions, when executed by the at least one processor, cause the at least one processor to, in response to receiving a user input, determine that at least one winning pattern is included on a base game bingo card by electronically comparing a base game ball call to the base game bingo card, cause a base game reel outcome to be displayed on a display including a set of reels, the base game reel outcome corresponding to the at least one winning pattern, determine that a feature game is triggered, in response to the feature game being triggered, determine that at least one new winning pattern is included (i) on a new bingo card by electronically evaluating the new bingo card using the base game ball call or (ii) on the base game bingo card by electronically evaluating the base game bingo card using a new ball call, and cause a new reel outcome to be displayed on the display including the set of reels, the new reel outcome corresponding to the at least one new winning pattern.

In another aspect, a method of providing a game at an electronic gaming device is provided. The method may include, in response to receiving a user input, determining that at least one winning pattern is included on a base game bingo card by electronically comparing a base game ball call to the base game bingo card, causing a base game reel outcome to be displayed on a display including a set of reels, the base game reel outcome corresponding to the at least one winning pattern, determining that a feature game is triggered, in response to the feature game being triggered, determining that at least one new winning pattern is included (i) on a new bingo card by electronically evaluating the new bingo card using the base game ball call or (ii) on the base game bingo card by electronically evaluating the base game bingo card using a new ball call, and causing a new reel outcome to be displayed on the display including the set of reels for the feature game, the new reel outcome corresponding to the at least one new winning pattern.

In another aspect, at least one non-transitory computer-readable storage media having computer-executable instructions embodied thereon is provided. When executed by at least one processor, the computer-executable instructions may cause the at least one processor to, in response to receiving a user input, determine that at least one winning pattern is included on a base game bingo card by electronically comparing a base game ball call to the base game bingo card, cause a base game reel outcome to be displayed on a display including a set of reels, the base game reel outcome corresponding to the at least one winning pattern, determine that a feature game is triggered, in response to the feature game being triggered, determine that at least one new winning pattern is included (i) on a new bingo card by electronically evaluating the new bingo card using the base game ball call or (ii) on the base game bingo card by electronically evaluating the base game bingo card using a new ball call, and cause a new reel outcome to be displayed on the display including the set of reels, the new reel outcome corresponding to the at least one new winning pattern.

In another aspect, an electronic gaming device including at least one memory with instructions stored thereon, and at least one processor in communication with the at least one memory is provided. The instructions, when executed by the at least one processor, cause the at least one processor to: in response to receiving a user input, initiate an electronic base game including: randomly provide an electronic bingo card for the base game, provide a base game ball call, determine that at least one winning pattern is included on the base game bingo card by electronically comparing the base game ball call to the base game bingo card and performing a lookup within an award pattern table, cause a reel outcome to be displayed on a set of reels corresponding to the at least one winning pattern; and determine that a feature game is triggered. The processor is further programmed to initiate the feature game by: randomly provide a new electronic bingo card for the feature game, determine that at least one winning pattern is included on the new bingo card by electronically comparing the base game ball call to the new bingo card and performing a lookup within the award pattern table, and cause a new reel outcome to be displayed on the set of reels for the feature game corresponding to the at least one winning pattern of the new bingo card.

In another aspect, an electronic gaming device including at least one memory with instructions stored thereon, and at least one processor in communication with the at least one memory is provided. The instructions, when executed by the at least one processor, cause the at least one processor to: in response to receiving a user input, initiate an electronic base game including: randomly provide an electronic bingo card for the base game, provide a base game ball call, determine that at least one winning pattern is included on the base game bingo card by electronically comparing the base game ball call to the base game bingo card and performing a lookup within an award pattern table, cause a reel outcome to be displayed on a set of reels corresponding to the at least one winning pattern. The processor is further programmed to determine that a feature game is triggered, and initiate the feature game by: randomly provide at least one new ball call for the feature game, determine that at least one winning pattern is included on the base game bingo card by electronically comparing the at least one new ball call to the base game bingo card and performing a lookup within the award pattern table, and cause a new reel outcome to be displayed on the set of reels for the feature game corresponding to the at least one winning pattern.

In another aspect, an electronic gaming device including at least one memory with instructions stored thereon, and at least one processor in communication with the at least one memory is provided. The instructions, when executed by the at least one processor, cause the at least one processor to: in response to receiving a user input, initiate an electronic base game including: randomly provide an electronic bingo card for the base game, provide a base game ball call, determine that at least one winning pattern is included on the base game bingo card by electronically comparing the base game ball call to the base game bingo card and performing a lookup within an award pattern table, cause a reel outcome to be displayed on a set of reels corresponding to the at least one winning pattern, and determine that a feature game is triggered. The processor is further programmed to initiate the feature game by: randomly provide a new electronic bingo card and at least one new ball call for the feature game, determine that at least one winning pattern is included on the new bingo card or the base bingo card by electronically comparing the base game ball call and the at least one new ball call to the based and new bingo cards, and performing a lookup within the award pattern table, and cause a new reel outcome to be displayed on the set of reels for the feature game corresponding to the at least one winning pattern of the new bingo card.

In another aspect, an electronic gaming device including at least one memory with instructions stored thereon, and at least one processor in communication with the at least one memory is provided. The instructions, when executed by the at least one processor, cause the at least one processor to: in response to receiving a user input, initiate an electronic base game including: randomly provide an electronic bingo card for the base game, provide a base game ball call, determine that at least one winning pattern is included on the base game bingo card by electronically comparing the base game ball call to the base game bingo card and performing a lookup within an award pattern table, cause a reel outcome to be displayed on a set of reels corresponding to the at least one winning pattern, and determine that a feature game is triggered. The processor is further programmed to initiate the feature game by: randomly provide multiple new electronic bingo cards and multiple new ball calls for the feature game, determine that at least one winning pattern is included on the base bingo card or the multiple new bingo cards by electronically comparing the base game ball call and the multiple new ball calls to the base bingo card and the multiple new bingo cards, and performing a lookup within the award pattern table, and cause a new reel outcome to be displayed on the set of reels for the feature game corresponding to the at least one winning pattern of the base bingo card and the multiple new bingo cards.

In another aspect, a method of providing a game at an electronic gaming device is provided. The method includes in response to receiving a user input, initiating an electronic base game including: randomly providing an electronic bingo card for the base game, providing a base game ball call, determining that at least one winning pattern is included on the base game bingo card by electronically comparing the ball call to the bingo card and performing a lookup within an award pattern table, causing a reel outcome to be displayed on a set of reels corresponding to the at least one winning pattern, and determining that a feature game is triggered. The method further includes initiating the feature game by: randomly providing a new electronic bingo card for the feature game, determining that at least one winning pattern is included on the new bingo card by electronically comparing the ball call from the base game to the new bingo card and performing a lookup within the award pattern table, and causing a new reel outcome to be displayed on the set of reels for the feature game corresponding to the at least one winning pattern of the new bingo card.

In another aspect, a non-transitory computer-readable storage medium is provided. The computer-executable instructions that when executed by at least one processor, cause the at least one processor to: in response to receiving a user input, initiate an electronic base game including: randomly provide an electronic bingo card for the base game, provide a base game ball call, determine that at least one winning pattern is included on the base game bingo card by electronically comparing the ball call to the bingo card and performing a lookup within an award pattern table, cause a reel outcome to be displayed on a set of reels corresponding to the at least one winning pattern, and determine that a feature game is triggered. The instructions when further executed initiate the feature game by: randomly provide a new electronic bingo card for the feature game, determine that at least one winning pattern is included on the new bingo card by electronically comparing the ball call from the base game to the new bingo card and performing a lookup within the award pattern table, and cause a new reel outcome to be displayed on the set of reels for the feature game corresponding to the at least one winning pattern of the new bingo card.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a block diagram showing various functional elements of an illustrative gaming machine configured to trigger multiple rounds of feature or bonus games from a single instance of a base game.

FIG. 5 is an illustrative gaming machine providing a bingo game configured to award bonus games.

FIG. 6 is an illustrative gaming machine providing a bingo game configured to award additional ball calls as part of a bonus game.

FIG. 7 is an illustrative gaming machine providing a bingo game configured to award additional bingo game cards as part of a bonus game.

FIG. 8 is an illustrative gaming machine providing a bingo game configured to award both an additional bingo card and additional ball calls as part of a bonus game.

FIG. 9 is an illustrative gaming machine providing a bingo game configured to award both additional ball calls and bingo game cards as part of a bonus game.

FIG. 10 is a flowchart of an embodiment of a method of enabling multiple bonus games on an EGM based on a single credit input.

FIG. 11 is a flowchart of an embodiment of a method of providing a bingo game that includes awarding additional bingo cards.

FIG. 12 is a flowchart of an embodiment of a method of providing a bingo game that includes awarding additional ball calls.

FIG. 13 is a flowchart of an embodiment of a method of providing a bingo game that includes awarding both an additional bingo card and multiple ball calls.

FIG. 14 is a flowchart of an embodiment of a method of providing a bingo game that includes awarding both additional bingo cards and bonus ball calls.

### DETAILED DESCRIPTION

The present application is directed to electronic gaming, and more specifically, to an electronic gaming system that is configured to trigger one or more rounds of bonus games from a single instance of a base game to extend game play and provide increased variability within the game. The base game may be a bingo-style game, in which each game instance of the base game includes evaluating one or more randomly generated or selected matrixes (referred to as “base game bingo cards”) using a randomly generated or received sequence of numbers (referred to as a “base game ball call”) and one or more pay tables that define winning patterns that can be formed when certain numbers of the ball call match corresponding positions of the bingo card. As described herein, an initial input from a player (e.g., a credit value input or wager) provides the player with a single instance of a base game, and the base game may trigger a feature/bonus game or multiple feature/bonus games. The bonus game may also utilize a bingo-style evaluation, and be evaluated using the base game bingo card and a new ball call, or may be evaluated using the base game ball call and a new bingo card. For example, in some exemplary embodiments, the system may generate or retrieve multiple bingo cards in response to a base game instance and, if an evaluation of a first (i.e., base game) bingo card triggers an award of a bonus game, one or more of the other bingo cards may then be evaluated using the ball call. Conversely, a base game bingo card may be evaluated using additional ball calls if a bonus game is triggered by an initial evaluation.

In some cases, these feature/bonus games (referred to herein below as feature games) may be referred to as a “red screen” feature game because the display device may display a visual effect (e.g., a red overlay) on the display screen during the feature game indicating to the player that the base game has transitioned to a feature game. In some embodiments, the player may input a spin command during the feature game but additional credit value inputs are not needed. Thus, these feature games may also be referred to as free spins. For purposes of this description, the duration of a game instance conventionally concludes at a time when the base game and any red screen free spin feature games end, at which time play may continue with a new credit input from the player.

Embodiments of the present disclosure represent a technical improvement in the art of electronic gaming machines, systems, and operating for such electronic gaming machines or systems. Technical improvements represented by the present disclosure include an EGM that triggers bonus/feature games based off of a single credit input (e.g., a wager). This feature increases a variability of potential display outcomes that may be generated using a given game display (e.g., a game matrix and one or more reels). Additionally, an automatic trigger of a bonus game relieves the player from having to decide whether to submit an additional credit input to continue a game. Play instead continues with an extended game. Additionally, the player receives positive feedback and excitement from bonus winnings and associated colorful, stimulating displays.

Additional technical improvements to the gaming machine include one or more processors configured to trigger a feature game from a base game outcome, and then trigger one of several different embodiments of a feature game operation including at least the following: (1) in response to the feature game being triggered, awarding additional bingo cards (one or more) to the player using the electronic gaming machine and evaluating the one or more newly provided bingo cards based on the base game ball call to determine whether one or more winning patterns are achieved; (2) in response to the feature game being triggered, outputting one or more additional ball calls and applying the one or more ball calls to the base game bingo card to determine whether one or more winning patterns are achieved; (3) in response to the feature game being triggered, awarding one or more additional bingo cards to the player using the electronic gaming machine and a new ball call, and applying the new ball call to the one or more new bingo cards to determine whether one or more winning patterns are achieved; and (4) in response to the feature game being triggered, awarding one additional bingo card to the player using the electronic gaming machine and one or more new ball calls, and applying the new ball calls to the new bingo card to determine whether one or more winning patterns are achieved.

These technical improvements are achieved by storing a virtual stack of bingo cards at the gaming device that may be used to randomly select one or more for the feature game, or by configuring the backend game server to provide one or more additional bingo cards to the gaming device for use in the feature game. In addition, the one or more processors may be used to generate one or more rounds of ball calls that may be used to evaluate the base game bingo card or additional bingo cards as part of the feature games. The ability to generate additional ball calls and/or provide additional bingo cards as part of the feature game, evaluate the additional ball calls and/or additional bingo cards using the base game bingo cards and/or base game ball call to identify pay patterns, and then present reel outcomes and awards based on this evaluation is a technical improvement that other known gaming systems are unable to achieve.

Another technical problem in the art of electronic gaming machines relates to conserving processing power and computing resources. It is generally desirable to implement additional electronic gaming features while minimizing usage of additional processing power and computing resources, which in some cases, may reduce performance of the electronic gaming machine or necessitate adding additional or more expensive computer hardware. The electronic gaming system described herein provides a technical solution to this problem by, when evaluating a feature game, reusing a ball call or bingo card from a previous instance of a base game, thereby eliminating a need for a new ball call or bingo card to be retrieved or generated for the bonus game. This reduces processing power and computing resources required to implement the feature game.

Another technical problem in the art of electronic gaming machines relates to conserving display area. Generally, electronic gaming machines have a limited amount of display area to convey information to the user. When additional features are added to an electronic game, these features generally need to use some of this limited display area. The electronic gaming system described herein provides a technical solution to this problem by using an overlaid translucent or transparent colored graphic effect, such as a red colored overlay or a “red screen,” to indicate that a feature game is active. The system is therefore capable of conveying this information without taking up additional display area.

Another technical problem exists in increasing variability and apparent randomness of display outcomes. By determining to execute a feature game and, in response, generating one or more additional ball calls or bingo cards, a greater variety of display outcomes may be presented in response to a given game instance of the electronic bingo game. Additionally, a random number generator and lookup and/or another algorithm may be used to select a facade to display for a given instance (e.g., based on the prize associated with a selected card) of both the base and feature game, which may provide randomness and variability in the display outcome. Accordingly, the system described herein solves this technical problem by increasing the randomness and/or variability of display outcomes that may be presented.

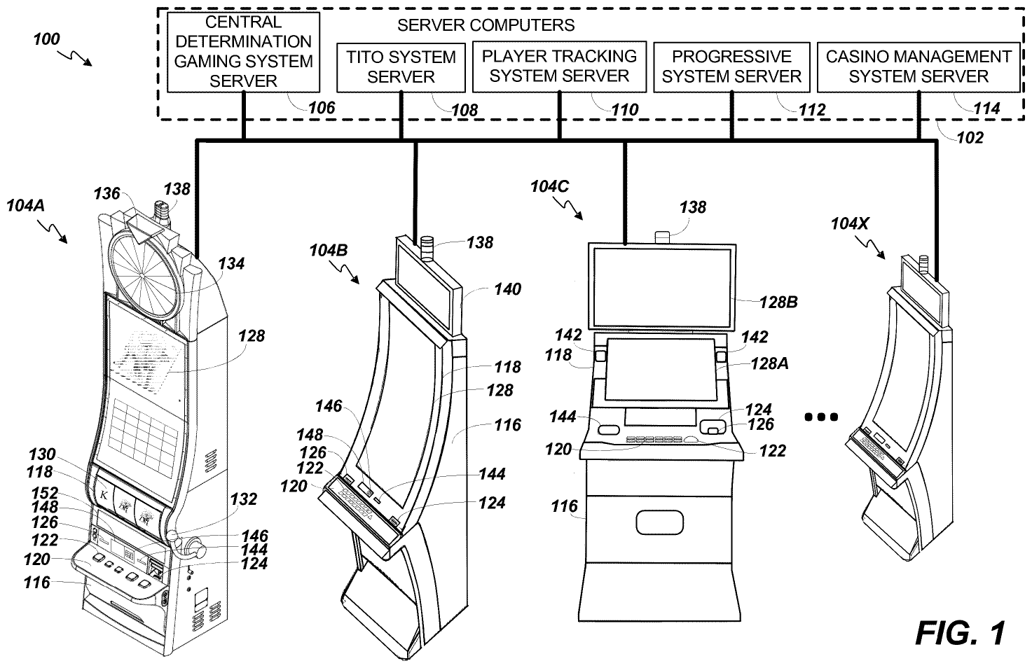

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server (not separately shown), a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main or service door 154 which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket (e.g., a voucher) to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming machine, total amount of money deposited, total amount of money withdrawn, total amount of winnings on gaming device 104A.

In some embodiments, a player tracking card reader 144, a transceiver for wireless communication with a player's smartphone, a keypad 146, and/or an illuminated display 148 for reading, receiving, entering, and/or displaying player tracking information is provided in gaming device 104A. In such embodiments, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game. Other bonus play may be presented on the display 148.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

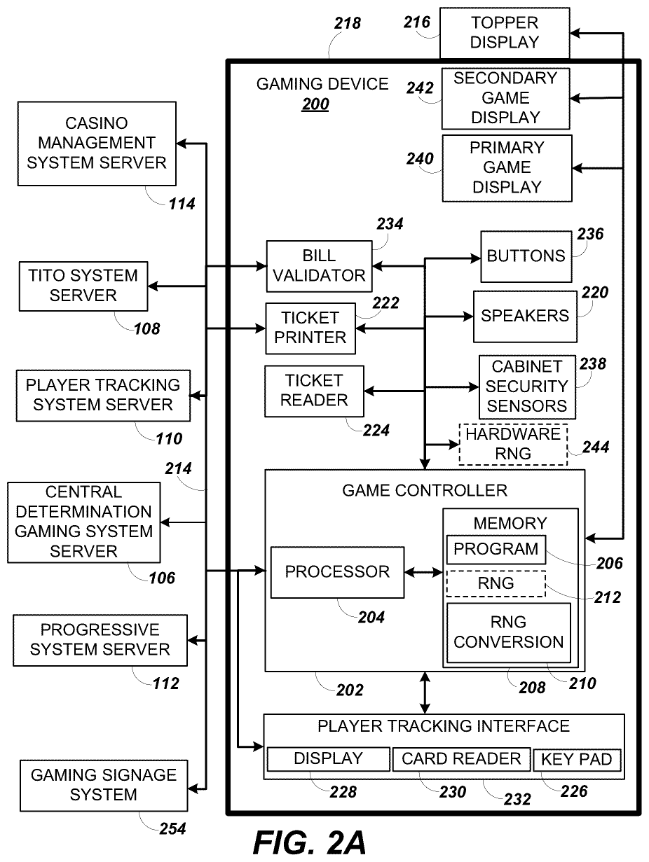

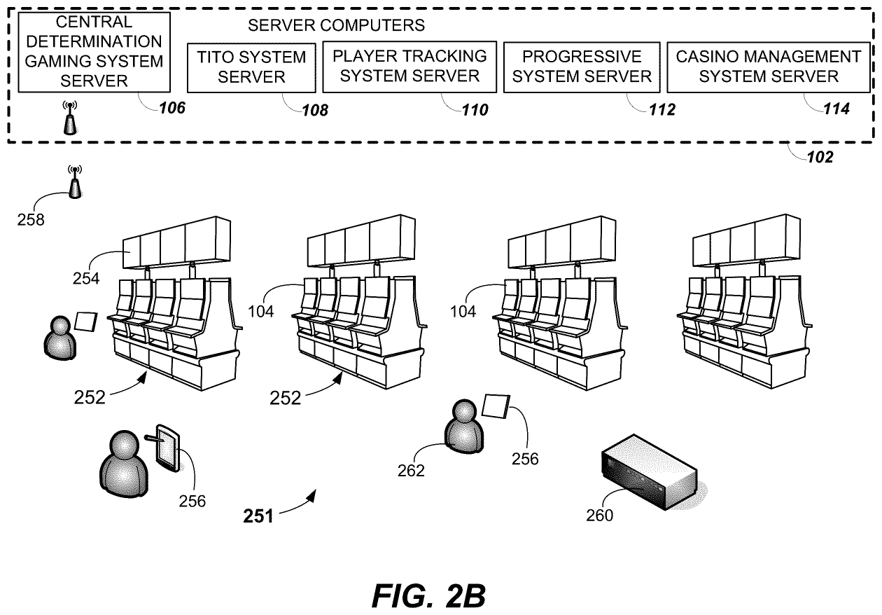

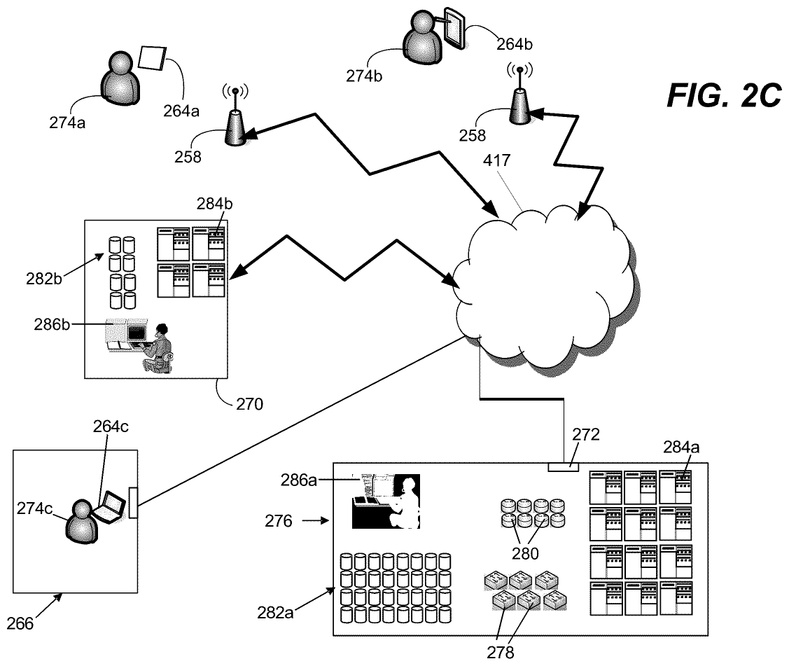

Many or all the above-described components can be controlled by circuitry (e.g., a gaming controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main or service door 154 which opens to provide access to the interior of the gaming device 104B. The main or service door 154 is typically used by service personnel to refill the ticket-out printer 126 and collect bills and tickets inserted into the bill validator 124. The main or service door 154 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator. In some embodiments, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

Any of the EGMs 104 may include a button deck 120. In the example embodiments described herein, the button deck 120 may include a button deck (not separately shown in FIG. 1) that includes one or more buttons 122 that may be configurable and that may be backlit by an LCD button deck display device within the button deck 120.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes a processor system that includes one or more processors. The processors may be collocated and/or distributed throughout the gaming device. Another processor comprising part of the processing system may be remotely located from the gaming device (e.g., at a remote server wirelessly connected to the gaming device). For example, processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically crasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place credit inputs on instances of the game and to receive credit awards based on the outcome of winning instances. The credit balance is decreased by the amount of each credit input and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections by using the player-input buttons 236, the primary game display 240 (e.g., a touch screen), or by using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network).

In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

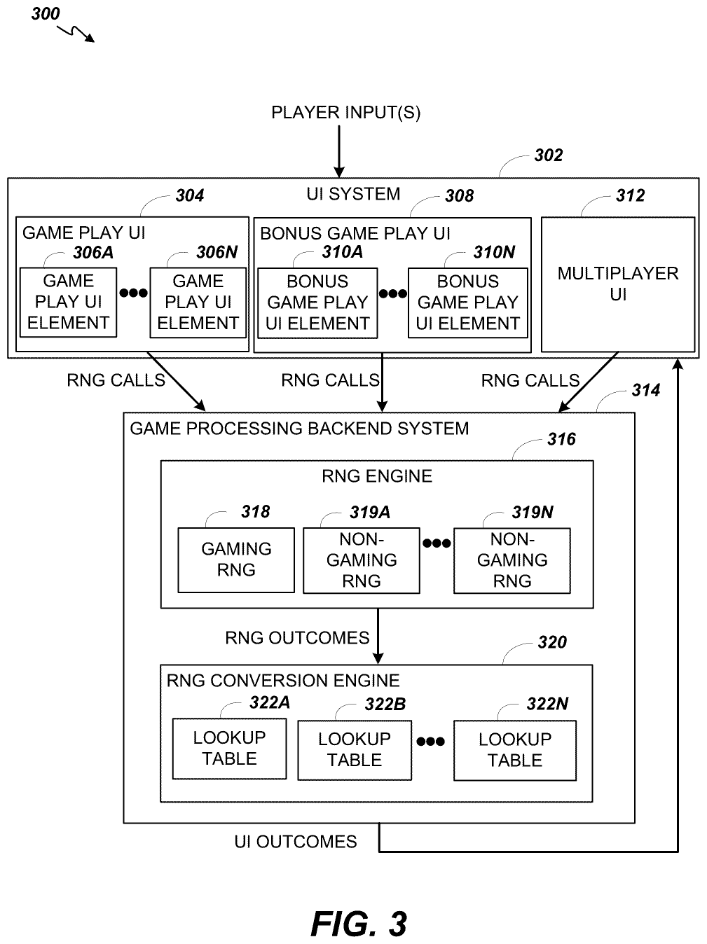

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

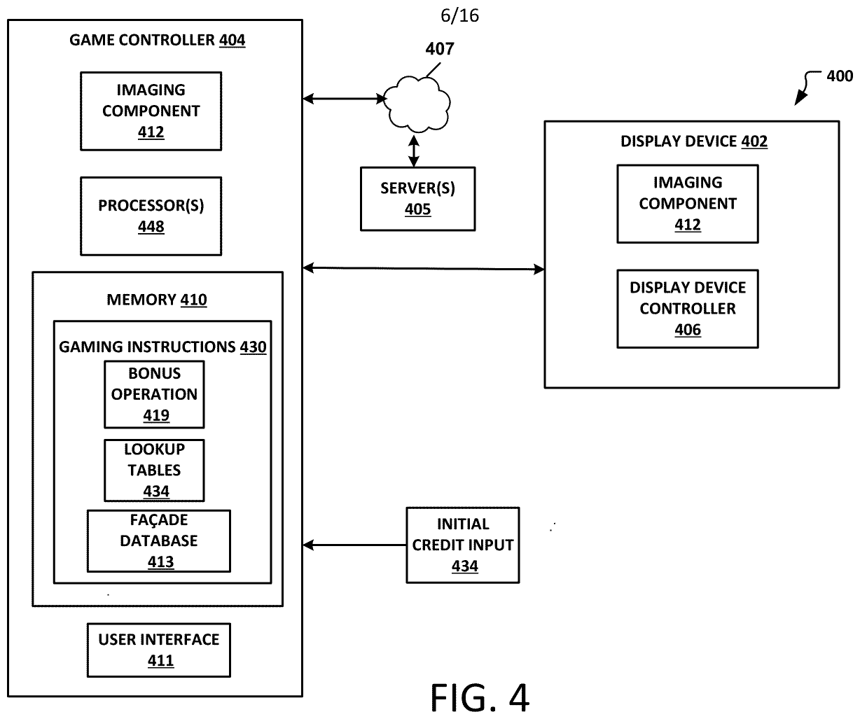

FIG. 4 is a block diagram depicting exemplary internal components of a gaming device 400 configured to initiate multiple secondary gaming processes (e.g., enabling bonus/feature rounds) based on a single credit input. More particularly, the gaming machine includes a display device 402, a memory 410 storing gaming instructions 430, and a game controller 404 comprising at least one processor 408 in communication with the memory 410 and a user interface module 411. The game controller 404 is configured to execute the gaming instructions 430 to receive an initial credit input 432. The game controller 404 may initiate a base game instance in response to receiving the initial credit input 432. In response to a completion of the game instance, the game controller 404 may initiate a bonus game operation 419 that extends the game. Associated processes may be responsive to or otherwise based off of the initial credit input 432 without requiring the player to re-wager. As such, the bonus game may be automatically triggered at a point at which play would otherwise end without another credit input or other action by the player to continue the game.

As shown in FIG. 4, the gaming device 400 additionally includes a display device 402 and an imaging component 412. In some embodiments, the game controller 404 may include more or fewer components. In the exemplary embodiment, the processor(s) 408 is in communication with imaging component 412 and the memory 410. Additionally, in the exemplary embodiment, the processor(s) 408 is in communication with a display device controller 406. In the exemplary embodiment, the game controller 404 may be configured to control the transmission of an image data signal to the display device 402.

As described herein, the memory 410 may include gaming instructions 430. The gaming instructions may include program code executed by the one or more processors 408 to implement the particular functions of an electronic game, such as an electronic game that displays reel outcomes based upon bingo cards and ball calls (Class II gaming), and/or in some cases based upon an RNG output (Class III gaming). The gaming instructions may include a particular function, such a bonus game operation 419, which enables additional game operation in certain instances without requiring an additional credit input 432. For example, the bonus game operation 419 may include providing the player with one or more additional ball calls. The additional ball calls may then be compared to the bingo game card to find additional daubs. In another example, the bonus game operation 419 may include providing one or more additional bingo cards. The additional bingo cards may be evaluated against the additional and/or prior ball calls to determine daubs. In still another example, the bonus game operation 419 may include providing both one or more bingo cards and one or more ball calls.

The bonus game operation 419 of an implementation may, in turn, result in the award of additional bonus rounds. In some configurations, additionally granted bonus rounds may be initiated in response to winning combinations on one or more bingo cards. In other implementations, the additional bonus rounds may be awarded regardless of whether any of the previously awarded card(s) included a winning combination. Such a configuration may include a trigger (and potential retriggers) that initiate another one or more bonus rounds in response to the gaming instances' impending conclusion. In either case, the bonus rounds are awarded without the player having to make a second credit input.

As shown in the embodiment of the gaming device 400 of FIG. 4, the memory 410 additionally includes lookup tables 434 that map a number of awarded ball calls and/or bingo card distributions to a game outcome displayed to the player. The lookup tables 434 may additionally function as a pay table for determining the prize payout amount for each bonus round evaluation. The pay table may be used to determine how many balls and/or bingo cards may be awarded according to a designed frequency in hitting certain prize payout amounts. Relatedly, awarded bonus bingo cards may have certain bingo patterns removed or added to the set of patterns included in the pay table to affect winning percentages.

As illustrated in the figures that follow, gaming device 400 may enable variations of bonus game scenarios. For example, a first type of bonus session may include awarding one or more additional bingo cards. The additional bingo cards, along with an original bingo card, may be evaluated against the primary (e.g., initial) ball call. A second bonus game implementation may include awarding one or more additional ball calls and evaluating all the ball calls against the original bingo card. A third illustrative bonus game may include awarding an additional bingo card and multiple additional ball calls. A fourth illustrative scenario may include providing both one or more additional cards and one or more additional ball calls. In such an embodiment of the system, the aggregated number of balls (i.e., those of the initial ball call, plus each subsequently awarded bonus ball call) may be evaluated against all of the accrued bingo cards (i.e., the base bingo card, plus each bonus bingo card).

In the example embodiment, the gaming device 400 may be a Class II gaming device. In a Class II gaming environment, a reel game outcome may recreate a Class II bingo game outcome. One skilled in the field will recognize that other embodiments of the system and the associated processes described herein may also be implemented using an E-ticket lottery instead of bingo cards or may be implemented using a Class III approach. In the scenario of a Class II gaming device implementation, a player and/or a gaming device 400 may be provided with a bingo card, such as by a bingo gaming system server 405. For example, a player may be provided a new bingo card each time a “Spin” or “Play” button is pressed by the player (e.g., via user interface), provided the player has made a wager or credit input. In some examples, more than one bingo card may be generated in response to a wager or credit input. A bingo number listing (also referred to as a “ball call”) may be randomly generated, such as by the bingo gaming system server. The bingo card may be compared to the current bingo number listing, and numbered cells on the bingo card that match numbers in the bingo number listing may be marked or “daubed” on the bingo card. Finally, the marked or daubed bingo card may be evaluated against a paytable of winning bingo patterns.

The bingo number listing may be continually generated until a maximum amount of numbers are listed (e.g., seventy-five numbers listed) or until a game-ending pattern is awarded to a player participating in the bingo game via the display device 402. A typical game-ending pattern may be a bingo card blackout pattern, in which each of the numbers of a bingo card match a number displayed in the bingo number listing. Other game-ending patterns are also possible. When the game-ending pattern is awarded, the bingo number listing is reset, and the process repeats. In some examples, a single play of the bingo game includes a credit input, a bingo card, a bingo number listing, a matching of the numbers listed with those on a bingo card, a determination of a bingo game outcome, and a presentation of an associated award, if any.

To determine a bingo game outcome, the bingo card may be daubed by the game controller 404 (e.g., via the processor 448) based upon a list of numbers included in the ball call. Once the bingo card is daubed, the game controller 404 may compare the numbers daubed on the bingo card to every winning pattern in a database of winning patterns (i.e., a bingo pay table) to determine one or more winning outcomes of the bingo game outcome. As those of skill in the art will appreciate, the number of winning patterns may be determined based upon the ball call. The daubed bingo card may also be displayed (e.g., on the primary display or the secondary display of the display device 402), such as, for example, by highlighting each daubed number, and the ball call may be displayed as well. Moreover, a table or database of winning patterns may be stored in a computer memory of any of the EGMs or gaming devices, which may be a tangible, non-transitory, computer-readable memory. If the daubed bingo card does not include a pattern that matches a pattern in the database of winning patterns, then a losing bingo outcome is determined, and no award may be provided or presented to the player. If the bingo card does include a pattern that matches a pattern in the database of winning patterns, then a winning bingo outcome is determined, and an award may be presented to the player, as described herein.

The bingo game outcome of the embodiment of gaming device 400 of FIG. 4 may include a plurality of winning patterns. Different winning patterns may be associated with different awards. The award for a winning bingo game outcome may be based on an amount wagered, an associated bingo game paytable, an associated set of rules for the bingo game, a probability (and/or likelihood) of achieving a particular bingo pattern/combination, an amount of bingo numbers needed to achieve the particular bingo pattern/combination, and/or other considerations. In some examples, the player may be awarded for multiple patterns (e.g., all winning patterns) that are matched when the daubed bingo card is evaluated against the database of winning patterns. In some examples, the player may be awarded for only the highest priority pattern (e.g., the highest paying winning pattern) that is matched. In some examples, during play of a Class II game, a player is provided or selects a single bingo card for multiple plays of the bingo game, with a new bingo number listing generated for each play of the bingo game. Other methods of play of a Class II bingo game are also possible and are within the scope of this disclosure.

As described herein, in Class II bingo game implementations, the game controller 404 and/or server 405 may determine a facade or reel outcome(s) for the reel game simulation to recreate the bingo game outcome. The reel game simulation is then controlled to display the facade and, in particular, one or more reel outcomes that award the prize, if any, associated with the bingo game outcome.

In example implementations, the game controller 404 and/or server 405 determines a facade for recreating the primary game outcome by selecting (e.g., based on a lookup) pre-built facades or individual presentation records for building the facade. A table or database may be stored in a computer memory of any of the EGMs or gaming devices and/or the gaming server, that associates primary game outcomes with facades for presenting the primary game outcomes. This table or database may be referred to as a facade database 413. The facade database 413 may include pre-built facades (i.e., pre-defined sets of one or more presentation records) or may include individual presentation records from which a facade may be built by the game controller and/or the game server. In some implementations, each facade in the facade database 413 may be stored as an RNG seed.

In some implementations, the facade database 413 may store pre-built facades for all possible outcomes of the primary game. Each pre-built facade may be associated with a primary game outcome (e.g., a certain primary game award value total) and includes one or more presentation records for presenting or recreating the associated primary game outcome. Once a primary game outcome is generated, the server and/or the game controller may query the facade database 413 to identify the pre-built facade(s) capable of presenting that outcome and select a facade from the identified set. For example, for a bingo pattern that awards 100 credits, a number of pre-built facades, e.g., five, ten, fifteen, or any other number of different pre-built facades, may exist with presentation record(s) that simulate a 100 credit award and are stored in the facade database 413. These pre-built facades are associated in the facade database 413 with the 100 credit award value of the bingo game outcome and are identified by the game controller and/or the server. One of the identified pre-built facades may then be randomly selected for presenting the primary game outcome, for example, based upon a random number provided by an RNG. When a pre-built facade is selected to present the primary game outcome, the game controller may control the reel game, via a user interface, to present the one or more spin and stop sequence(s) contained in the facade.

In other implementations, the facade database 413 may store individual presentation records from which facades for all possible outcomes of the primary game may be built (e.g., by the game controller and/or the server). Each presentation record may be associated with an award value (e.g., 5 credits, 10 credits, 50 credits, 100 credits, etc.), that is, the presentation record simulates a reel game outcome, or a spin and stop sequence of the reel game, that awards the associated award value. Once a primary game outcome is generated, the server 405 and/or the game controller 404 may query the facade database 413 and, based on the award value total associated with the primary game outcome, build the facade with one or more presentation records stored in the facade database 413 that collectively present that award value total. For example, for a bingo pattern that awards 100 total credits, the server and/or the game controller may build a facade for presenting that award total with a presentation record having an associated award value of 100 credits, or with two presentation records each having an associated award value of 50 credits, or with a presentation record having an associated award value of 50 credits and two presentations records each having an associated award value of 25 credits. The process by which the server and/or game controller builds a facade using the presentation records stored in the facade database 413 is not particularly limited and may be performed using an iterative process or by one or more random selections of presentation records. When a facade is built to present the primary game outcome, the game controller may control the reel game to present the one or more spin and stop sequence(s) contained in the facade.

When the facade is presented, the user interface is controlled by the game controller to visually indicate that the symbols displayed in the reel matrix during the reel outcome(s) of the facade either result in a winning outcome if the facade is associated with a winning primary game outcome or a losing outcome if the facade is associated with a losing primary game outcome. In winning reel game outcomes, the user interface may be controlled to visually indicate that one or more combinations of symbols and/or one or more special symbol types displayed in the reel matrix result in an award value that is subsequently credited to the player, and the total award value across all the reel game outcomes of the facade equal the award value of the winning primary game outcome. Similarly, a losing primary game outcome may be displayed as a losing outcome of the reel game in which no winning symbol combinations or winning special symbol types are displayed in the reel matrix.

As described herein, a facade for presenting a given primary game outcome may include a single presentation record or multiple presentation records. In the example implementation, the reel game includes a base game mode and a feature or bonus game mode. When a facade includes multiple presentation records, one or some of the presentation records may be displayed as part of a base game in the base game mode, and the remaining presentation records may be displayed as part of a feature game in the feature game mode. In particular, the feature game may be a free spins feature game in which the remaining presentation records or spin and stop sequences of the facade are displayed after display of the presentation records as part of the base game. As described in further detail below, in the example implementation, the feature game may be a red screen free spin and may include multiple spins of the feature game, and, in some cases, may include a retriggering of multiple feature games. Whether a feature game is triggered may be based at least in part on the winning patterns table and/or paytables of the base game stored in the memory.

In the example implementation, the free spins feature game is “triggered” in response to the game controller and/or server determining that a trigger condition is satisfied by the primary or base game outcome. As described in further detail below, the trigger condition may be defined within the winning patterns table stored within the database. In other words, during the base game, a bingo card may be provided to the gaming device or EGM; the ball call happens, and the evaluation occurs determining whether there is a winning pattern for the player. If there is a winning pattern, a lookup is performed to determine what award is to be provided. When the lookup to determine the winning pattern is performed, a flag or a feature game trigger may also be associated with the winning pattern such that the player is also awarded a feature game (e.g., red screen free spins). As part of the feature game, on or more additional bingo cards and/or ball calls may be provided to the player via the gaming machine to determine whether the player is awarded additional credits as part of the feature game. These additional bingo cards and/or ball calls may be provided as part of several different embodiments of the present disclosure described herein. These additional bingo cards and/or ball calls may be used to generate one or more feature games such that the comparison of the bingo cards and/or ball calls may generate a feature game award output that results in a feature game façade being displayed to the player.

The transition between the base game user interface and the feature game user interface may include display of one or more indications that the free spins feature game is distinct from the base game. For example, the feature game user interface may include an overlaid translucent or transparent colored graphic effect, such as a red colored overlay or a “red screen.” The red screen may be displayed for the duration of the feature game. Additionally and/or alternatively, the game controller may cause display of animation (e.g., words, symbols, letters, metamorphics, and/or other visual effects) on the feature game user interface to visually distinguish the free spins feature game from the base game.

In the example embodiment, the single round or multiple rounds of feature games may be implemented in several different ways. The multiple embodiments of implementing this novel feature game operation include the following: (1) in response to the feature game being triggered, award additional bingo cards (one or more) to the player using gaming device 400, the one or more newly provided bingo cards are then evaluated based on the base game ball call to determine whether one or more winning patterns are achieved; (2) in response to the feature game being triggered, output one or more additional ball calls and apply the one or more ball calls to the base game bingo card to determine whether one or more winning patterns are achieved; (3) in response to the feature game being triggered, award one or more additional bingo cards to the player using gaming device 400 and one new ball call, and apply the new ball call to the one or more new bingo cards to determine whether one or more winning patterns are achieved; and (4) in response to the feature game being triggered, award one additional bingo card to the player using the electronic gaming machine and one or more new ball calls, and apply the new ball calls to the new bingo card to determine whether one or more winning patterns are achieved.

In this manner, the feature games may include providing the player with one or more additional ball calls and/or one or more additional game cards. The additional ball calls may then be compared to the bingo game card(s) to find additional daubs. The feature game operation of an implementation may, in turn, result in the award of additional feature or bonus games. In this manner, a game may be extended to award winnings on top of prior winnings, on top of other prior winnings, and all on a single credit input (i.e., a single wager). In some configurations, the additionally granted feature/bonus round(s) may be triggered in response to winning combinations on one or more bingo cards. In other implementations, the additional bonus round(s) may be awarded regardless of whether any of the previously awarded card(s) included a winning combination. Such a configuration may include a trigger (and potential retriggers) that trigger another one or more bonus rounds in response to the game's impending conclusion. In either case, the bonus rounds are awarded without the player having to make a second credit input.

An implementation may display special graphics concurrently with awarding the additional bonus/feature games. One such graphics example may include a red screen free spins display. The display may inform the player of the bonus operation and infuse a level of excitement associated with winning at the electronic game. Certain embodiments of the system may virtually stack such red screen free spin windows, or facades, on top of one another. For instance, a bonus operation may spawn multiple additional bonus operations. In one such case, the display may present multiple red screen free spin facades virtually stacked on top of one another in an order according to their respective size of winnings. In a specific example, bonus awards may result in four additional evaluations. The player may thus be presented with four facades of the red screen free spin windows. The facades may be pulled for each payout while being presented as a re-spin. As with other embodiments described herein, the user may be presented the multiple bonus windows after placing a single credit input.

According to a particular embodiment, the number of the awarded ball calls and/or the awarded bingo cards may increase with each subsequently provided bonus round. For example, a player may place their wager and begin an instance of a base game on the gaming device. The game may initially provide forty or so balls that are matched against a primary, original bingo card to determine whether one or more winning bingo card patterns are present during the base game. The outcome of the base game evaluation may be presented to the player. The outcome of the base game instance may trigger a first bonus/feature round without the player making another credit input or wager. The first bonus round may award a second ball call having an initial forty or so balls presented for evaluation against the same bingo card or another bingo card, while a second bonus round may award a third ball call having another initial set of forty or so balls called. In some cases, all of the balls from each round may be evaluated against the original, base bingo card and any subsequently awarded bingo cards. The game may report the outcome of the evaluations for each bonus round. As described herein, another or the same embodiment of the system may award an increasing number of additional bingo cards during one or more bonus/feature rounds, each based off of the original credit input.

As described herein, lookup tables 434 may be used to regulate a prize award amount for each bonus round outcome and how often the gaming device awards the prize amounts. One or more processors 448 of the game controller 404 may execute gaming instructions 430 that use a lookup table 434 to map a number of awarded ball calls and/or bingo card distributions to a game outcome displayed to a player. A second lookup table of the lookup tables 434 may function as a pay table for determining the prize award amount for each bonus round evaluation. The pay table may be used to determine how many rounds of ball calls and/or bingo cards may be awarded. Relatedly, awarded bonus bingo cards may have certain bingo patterns removed or added to change winning percentages and/or RTP.

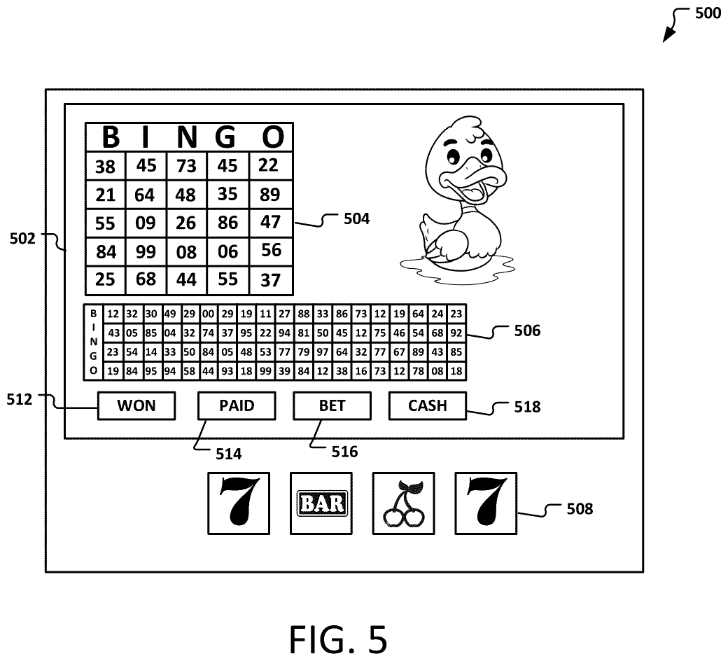

FIG. 5 is an illustrative gaming machine 500 providing an electronic game that includes a set of reels 508 and a backend bingo game configured to award bonus games that are presented using reels 508. The gaming machine 500 includes a digital display 502 that depicts a base, or initially presented, bingo card 504 and an initial ball call 506. The gaming machine 500 additionally includes mechanical or virtual reels 508, which may be similar to reels 130 of FIG. 1, and may be used for displaying reel outcomes (e.g., base game reel outcomes or feature game or “new” reel outcomes) determined by the bingo game. Additional features of the gaming machine 500 may include a data field 512 displaying an amount of credits won and another field 514 displaying an amount of credits that have been paid. Another field 516 may show a current amount of credits bet, while another field 518 may show a current cash value available for placing a wager.

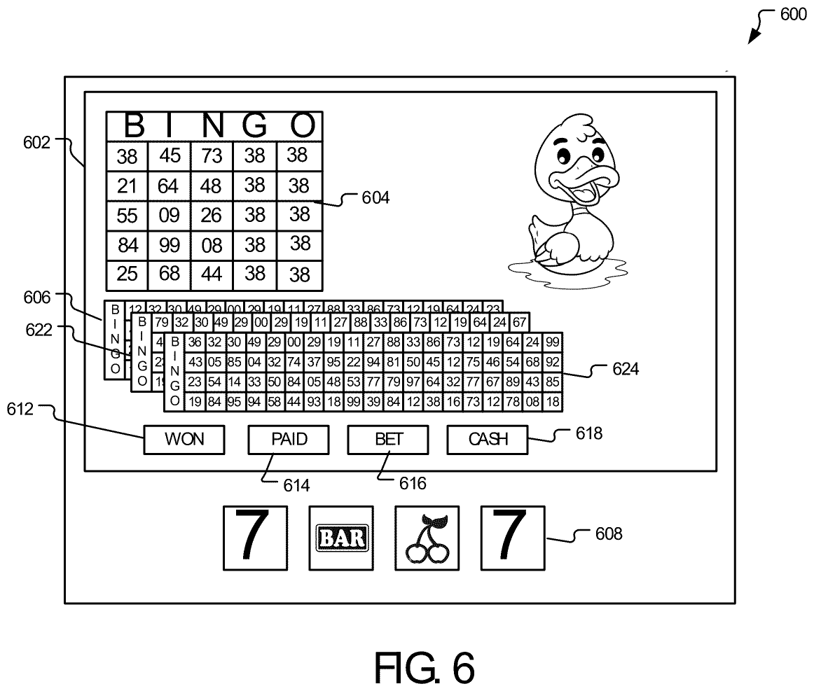

FIG. 6 is an illustrative gaming machine 600 providing an electronic game that includes a set of reels 608 and a backend bingo game configured to award bonus games that are presented using reels 608. Machine 600 is configured to award additional ball calls 622, 624 as part of a bonus game. The additional ball calls 622, 624, along with an original ball call 606, may be evaluated against the primary (i.e., initial) bingo game card 604.

The gaming machine 600 includes a digital display 602 that depicts the base, or initially presented, bingo card 604. The display additionally shows an initial ball call 606. The ball call 606 may be similar to the ball call 506 of FIG. 5. The gaming machine 600 additionally includes reels 608, which may be similar to reels 130 of FIG. 1. Additional features of the gaming machine 600 may include a field 612 displaying an amount of credits won and another field 614 displaying an amount of credits that have been paid. Another field 616 may show a current amount of credits bet, while another field 618 may show a current cash value of credits available for placing a wager.

According to a particular embodiment, the number and/or size of the awarded ball calls may increase with each subsequently provided bonus round. For example, a player may place their wager and begin play of an instance of a base game on an electronic gaming device. The base game may initially provide one ball call to be evaluated against an initial bingo card to determine whether one or more winning bingo card patterns are present. The outcome of the evaluation may be presented to the player. The outcome of the base game instance may trigger a first bonus round without the player making another credit input. The first bonus round may award five additional ball calls, while a third bonus round may award twenty additional ball calls. The aggregated twenty-six ball calls may be evaluated against the original bingo game card 504. The game may report outcome of the evaluations in between each bonus round. As described herein, another or the same embodiment of the gaming system may award an increasing number of new bingo cards during bonus rounds, each based off of the original credit input.

An implementation of the game may display special graphics concurrently with awarding the additional bonus games. One such graphics example may include a red screen free spins display. The display may inform the player of the bonus operation and infuse a level of excitement associated with winning at the electronic game. Certain embodiments of the system may virtually stack such red screen free spin windows, or facades, on top of one another. For instance, a bonus operation may spawn multiple additional bonus operations. In one such case, the display may present multiple red screen free spin facades virtually stacked on top of one another in an order according to their respective size of winnings. In specific example, bonus awards may result in four additional evaluations. The player may thus be presented with four facades of the red screen free spin windows. The facades may be pulled for each award while being presented as a re-spin. As with other embodiments described herein, the user may be presented the multiple bonus windows after placing a single credit input.

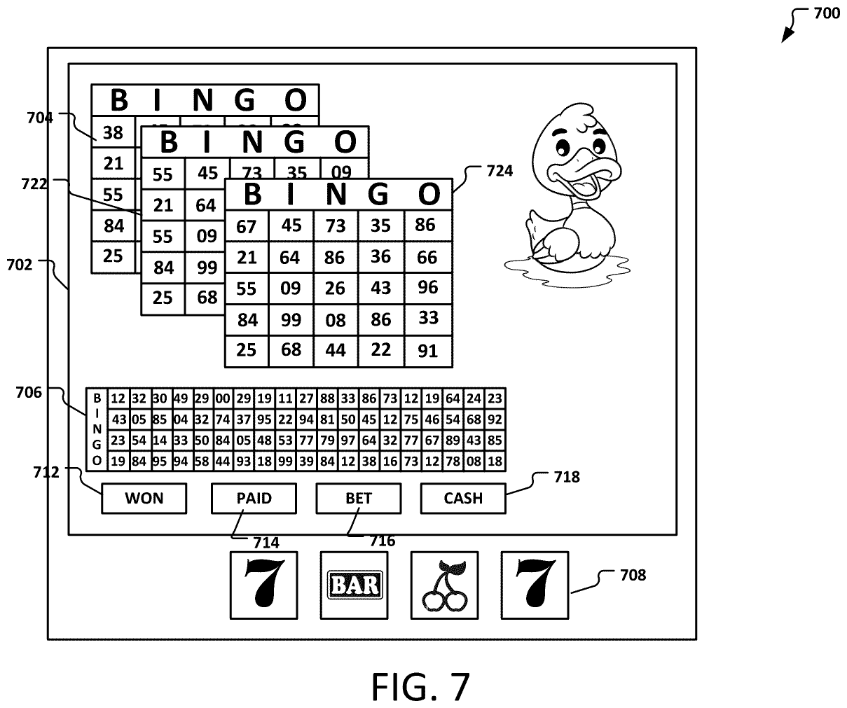

FIG. 7 is an illustrative gaming machine 700 providing an electronic game that includes a set of reels 708 and a backend bingo game configured to award bonus games that are presented using reels 708. Machine 700 is configured to award additional bingo game cards 722, 724 as part of a bonus game instance. The additional bingo cards 722, 724, along with an original bingo card 704, may be evaluated against the primary (i.e., initial) ball call 706. The gaming machine 700 includes a digital display 702 that depicts a base, or initially presented, bingo card 704. The display additionally shows an initial ball call 706. The ball call 706 may be similar to the ball call 506 of FIG. 5. The gaming machine 700 additionally includes reels 708, which may be similar to reels 130 of FIG. 1. Additional features of the gaming machine 700 may include a field 712 displaying an amount of credits won and another field 714 displaying an amount of credits that have been paid. Another field 716 may show a current amount of credits bet, while another field may show a current cash value of credits available for placing a wager.

According to a particular embodiment, the number and/or size of the awarded bingo cards 704, 722, 724 may increase with each subsequently provided bonus round. For example, a player may place their wager and begin an instance of a base game on the gaming device. The game may initially provide one bingo card to be matched against the initial ball call 706 to determine whether one or more winning bingo card patterns are present. The outcome of the base game evaluation may be presented to the player. The outcome of the base game instance may trigger a first bonus round without the player making another credit input. The first bonus round may award one additional card, while a second bonus round may award five additional bingo cards. In such a scenario, all seven cards may be evaluated against the original ball call. The game may report the outcome of the evaluations in between each bonus round. As described herein, another or the same embodiment of the system may award an increasing number of additional bingo cards during one or more bonus rounds, each based off of the original credit input.

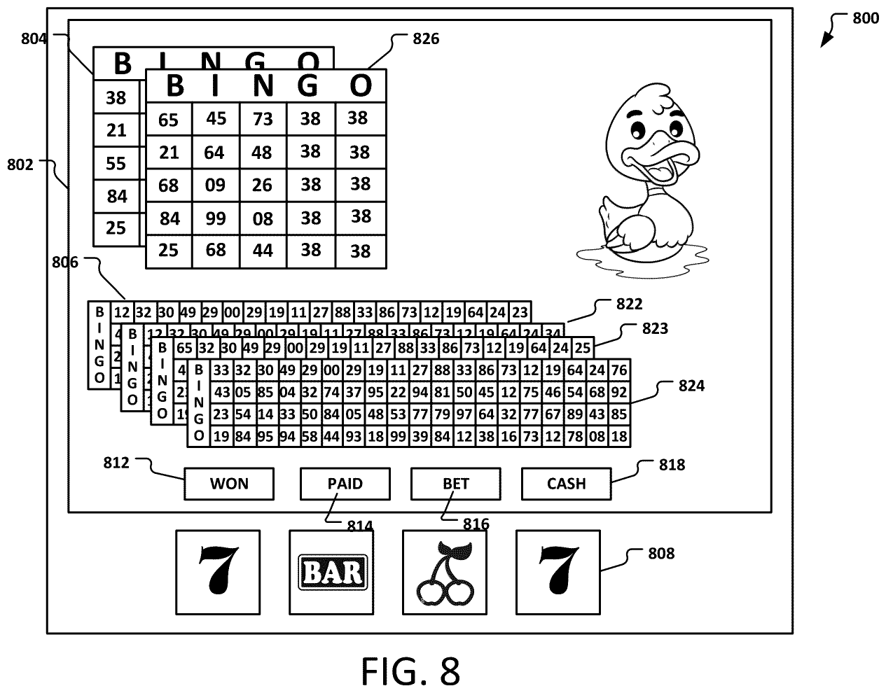

FIG. 8 is an illustrative gaming machine 800 providing an electronic game that includes a set of reels 808 and a backend bingo game configured to award bonus games that are presented using reels 808. Machine 800 is configured to award both an additional bingo game card 828 and additional ball calls 822-824 as part of a bonus game. In such an embodiment of the system, the aggregated number of balls (i.e., those of the initial ball call, plus each subsequently awarded bonus ball call) may be evaluated against all of the accrued bingo cards (i.e., the base bingo card 704 plus the bonus bingo card 728).

The gaming machine 800 includes a digital display 802 that depicts a base, or initially presented, bingo card 804. The display additionally shows an initial ball call 806. The ball call 806 may be similar to the ball call 506 of FIG. 5. The gaming machine 800 additionally includes reels 808, which may be similar to reels 130 of FIG. 1. Additional features of the gaming machine 800 may include a field 812 displaying an amount of credits won and another field 814 displaying an amount of credits that have been paid. Another field 816 may show a current amount of credits bet, while another field 818 may show a current cash value of credits available for placing a wager.

According to a particular embodiment, the size of the awarded ball calls and/or the awarded bingo cards may increase with each subsequently provided bonus round. For example, a player may place their wager and begin an instance of a base game on the gaming device. The game may initially provide forty or so balls that are matched against a primary, original bingo card to determine whether one or more winning bingo card patterns are present. The outcome of the base game evaluation may be presented to the player. The outcome of the base game instance may trigger a first bonus round without the player making another credit input. The first bonus round may award an additional set of balls, while a second bonus round may award another additional set of balls. All ball calls may be evaluated against the base bingo card and the awarded bingo card. The game may report the outcome of the evaluations in between each bonus round. As described herein, another or the same embodiment of the system may award an increasing number of additional bingo cards during one or more bonus rounds, each based off of the original credit input.

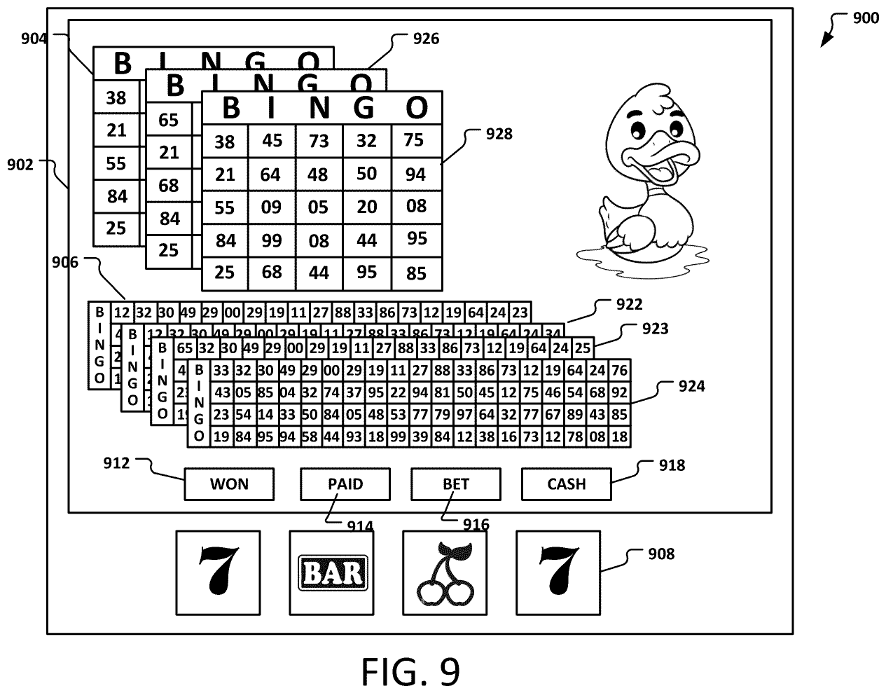

FIG. 9 is an illustrative gaming machine 900 providing an electronic game that includes a set of reels 908 and a backend bingo game configured to award bonus games that are presented using reels 908. Machine 900 is configured to award both additional ball calls 922-924 and bingo game cards 926, 928 as part of a bonus game. In such an embodiment of the system, the aggregated number of balls (i.e., those of the initial ball call, plus each subsequently awarded bonus ball call) may be evaluated against all of the accrued bingo cards (i.e., the base bingo card, plus each bonus bingo card).

The gaming machine 900 includes a digital display 902 that depicts a base, or initially presented, bingo card 904. The display additionally shows an initial ball call 906. The ball call 906 may be similar to the ball call 506 of FIG. 5. The gaming machine 900 additionally includes reels 908, which may be similar to reels 130 of FIG. 1. Additional features of the gaming machine 900 may include a field 912 displaying an amount of credits won and another field 914 displaying an amount of credits that have been paid. Another field 916 may show a current amount of credit bet, while another field 918 may show a current cash value of credits available for placing a wager.

According to a particular embodiment, the size of the awarded ball calls and/or the awarded bingo cards may increase with each subsequently provided bonus round. For example, a player may place their wager and begin an instance of a base game on the gaming device. The game may initially provide balls that are matched against a primary, original bingo card to determine whether one or more winning bingo card patterns are present. The outcome of the base game evaluation may be presented to the player. The outcome of the base game instance may trigger a first bonus round without the player making another credit input. The first bonus round may award an additional set of balls, while a second bonus round may award another additional set of balls. All balls may be evaluated against the original, base bingo card and any subsequently awarded bingo cards. The game may report the outcome of the evaluations in between each bonus round. As described herein, another or the same embodiment of the system may award an increasing number of additional bingo cards during one or more bonus rounds, each based off of the original credit input.

In one particular payout example, a player may be awarded four bonus bingo cards that each include multiple winning patterns. More particularly, each of the four bingo cards may include five winning patterns. An embodiment may present the winning patterns in a variety of ways. For instance, one presentation output may include four rounds of red screen feature games. As such, the first round may play out with five free spins. Each free spin may award a payout for the five winning patterns. These results may be shown in ascending order. For instance, the first free spin may show a fifty-credit win. The next free spin may show a one hundred credit win, and the next free spin may show a one hundred fifty credit win (and so on for five wins). On spin five, the system may retrigger a next feature game for five more spins and five winning payouts for the second card until all four cards are paid out.

In another payout example, a feature game may include a mega game where all of the winning patterns of all four cards are combined together and the aggregate amount is split up and paid out with one big red screen feature game. For instance, ten spins may be awarded by RNG and the total credit of all twenty patterns may be paid out over the ten spins. One skilled in the art will appreciate that other payout combinations are possible.

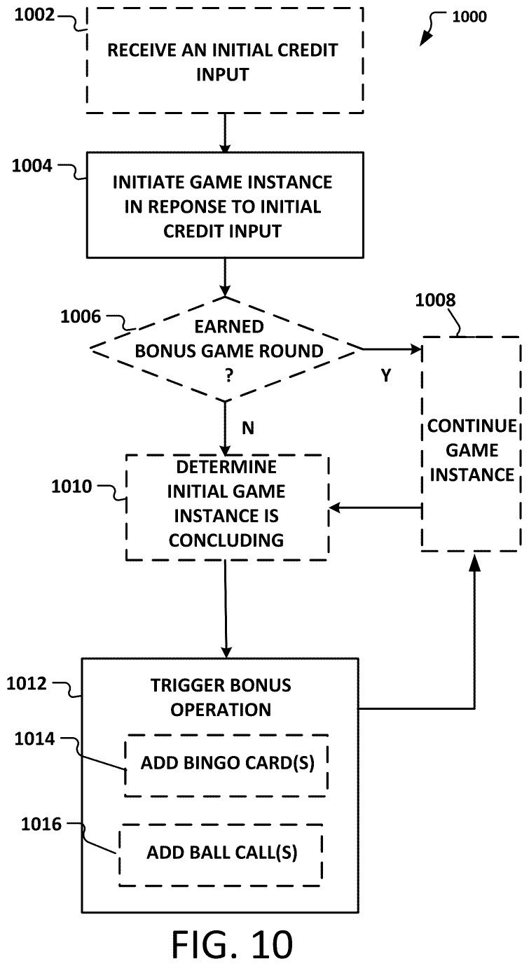

FIG. 10 is a flowchart of an embodiment of a method 1000 of providing an electronic game that includes a set of reels and a backend bingo game configured to award bonus games that are presented using the reels. The illustrative method 1000 may be performed by any of the preceding systems described in FIGS. 1-9. Dashed lines indicate that the associated processes may be optionally implemented as specifically programmed.

Turning more particularly to the flowchart, the embodiment of the method 1000 at step 1002 may receive an initial credit input from a player. For instance, the gaming device 400 of FIG. 4 may receive a credit input 432 at a user interface module 411.

At step 1004, the method 1000 may include initiating a game instance in response to the initial credit input. For example, the game controller 404 of FIG. 4 may trigger a bingo game (such as is shown in FIG. 5) in response to the credit input 432.

The method 1000 may determine at 1006 if a bonus game round has been earned by the player. A bonus game round of an embodiment may be awarded on merit by virtue of an evaluation matching ball call data with patterns on a bingo card. The bonus game round may allow play to continue at step 1008. For instance, a player may be awarded additional ball calls as a spin-related award.

Where a game instance is determined to be near or otherwise at its conclusion at step 1010, the illustrative method 1000 may award a bonus operation at step 1102. The bonus operation at step 1012 may be triggered without the player having to make a second credit input. The bonus operation of a particular embodiment may be triggered regardless of whether a match has been achieved for the bingo card(s). For example, the method 1000 may include a programmatic trigger that automatically awards additional bingo cards at step 1014 and/or additional ball calls at step 1016. For instance, the game controller 404 of FIG. 4 may trigger a bonus game operation 419 that awards at least one of a game card and/or a ball call (such are shown in FIGS. 5-9). Thus, in response to a completion of the game instance, the method 1000 may award a bonus game operation that extends the game instance back at step 1008, still based off of the initial wager made back at step 1002.

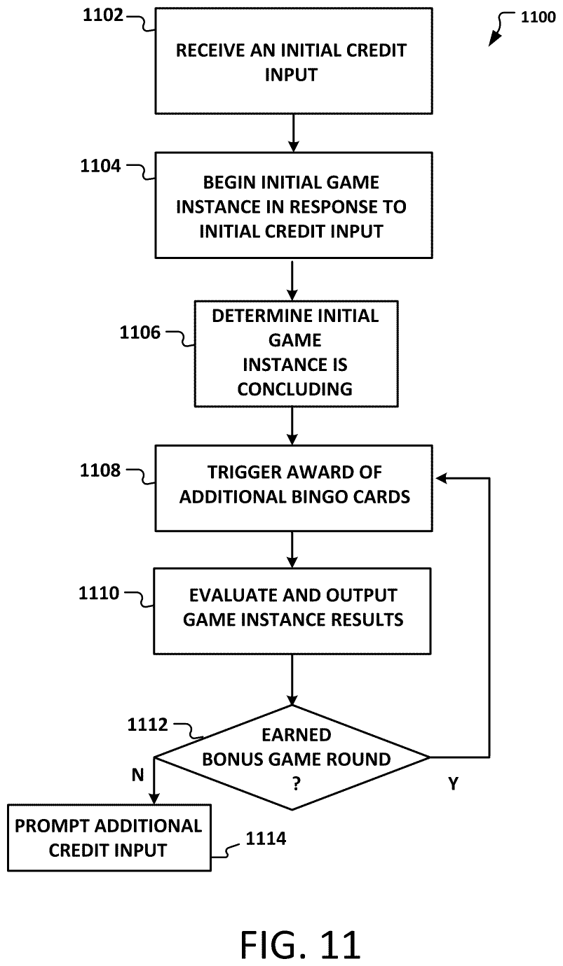

FIG. 11 is a flowchart of an embodiment of a method 1100 of providing an electronic game that includes a set of reels and a backend bingo game configured to award bonus games that are presented using the reels. The illustrative method 1100 may be performed by any of the preceding systems described in FIGS. 1-5 and 7.

Turning more particularly to the flowchart, the embodiment of the method 1100 at step 1102 may receive an initial credit input from a player. For instance, the gaming device 400 of FIG. 4 may receive a credit input 432 at a user interface module 411.

At step 1104, the method 1100 may include initiating a game instance in response to the initial credit input. For example, the game controller 404 of FIG. 4 may trigger a bingo game (such as is shown in FIG. 7) in response to the credit input 432.

Where the game instance is determined to be near or otherwise at its conclusion at step 1106, the illustrative method 1100 may award bonus bingo cards at 1108. The bonus operation at step 1108 may be triggered without the player having to make a second credit input. The bonus operation of a particular embodiment may be triggered regardless of whether a match has been achieved for the bingo card(s). For example, the method 1100 may include a programmatic trigger that automatically awards additional bingo cards at step 1108. For instance, the game controller 404 of FIG. 4 may trigger a bonus game operation 419 that awards at least one of a game card (as shown in FIG. 7). Thus, in response to a completion of the game instance, the method 1100 may award a bonus game operation that extends the game instance, still based off of the initial wager made back at step 1102.

The method 1100 may evaluate the awarded bingo cards against the original ball call at 1110. In turn, the method may report or otherwise output the results of the evaluation to the player.

The method 1100 may determine at 1112 if a bonus game round has been earned by the player. A bonus game round of an embodiment may be awarded on merit by virtue of an evaluation matching ball call data with patterns on a bingo card. If so, play may continue with another bonus operation at 1108. Otherwise, the system may prompt the user for additional credit input to continue the game session at 1114.

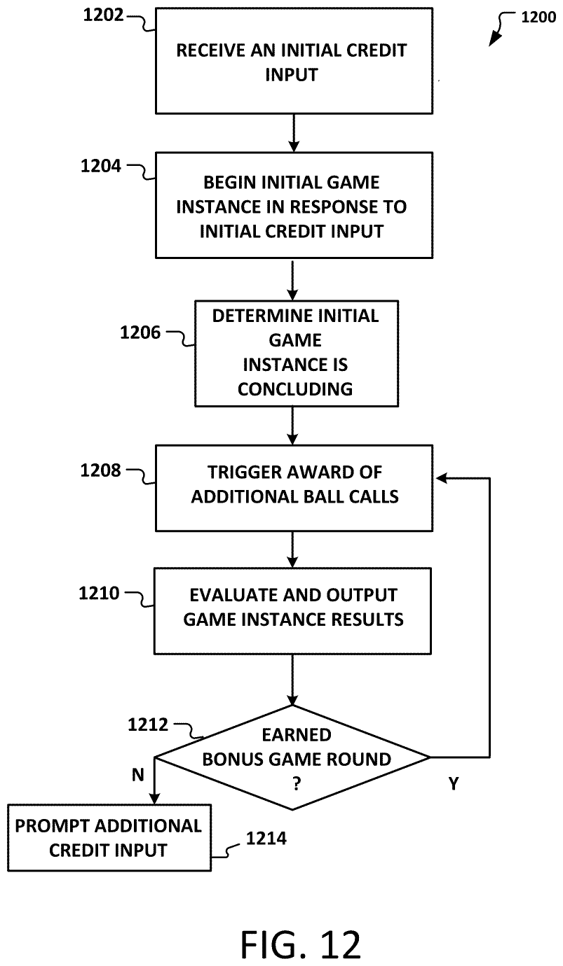

FIG. 12 is a flowchart of an embodiment of a method 1200 of providing an electronic game that includes a set of reels and a backend bingo game configured to award bonus games that are presented using the reels. The illustrative method 1200 may be performed by any of the preceding systems described in FIGS. 1-6.

Turning more particularly to the flowchart, the embodiment of the method 1200 at step 1202 may receive an initial credit input from a player. For instance, the gaming device 400 of FIG. 4 may receive a credit input 432 at a user interface module 411.

At step 1204, the method 1200 may include initiating a game instance in response to the initial credit input. For example, the game controller 404 of FIG. 4 may trigger a bingo game (such as is shown in FIG. 6) in response to the credit input 432.

Where the game instance is determined to be near or otherwise at its conclusion at step 1206, the illustrative method 1200 may award bonus ball calls at 1208. The bonus operation at step 1208 may be triggered without the player having to make a second credit input. The bonus operation of a particular embodiment may be triggered regardless of whether a match has been achieved for the ball calls. For example, the method 1200 may include a programmatic trigger that automatically awards additional ball calls at step 1208. For instance, the game controller 404 of FIG. 4 may trigger a bonus game operation 419 that awards at least one of a ball call (as shown in FIG. 6). Thus, in response to a completion of the game instance, the method 1200 may award a bonus game operation that extends the game instance, still based off of the initial wager made back at step 1202.

The method 1200 may evaluate the awarded ball calls against the base bingo card at 1210. In turn, the method may report or otherwise output the results of the evaluation to the player.

The method 1200 may determine at 1212 if a bonus game round has been earned by the player. A bonus game round of an embodiment may be awarded on merit by virtue of an evaluation matching ball call data with patterns on the bingo card. If so, play may continue with another bonus operation at 1208. Otherwise, the system may prompt the user for additional credit input to continue the game session at 1214.

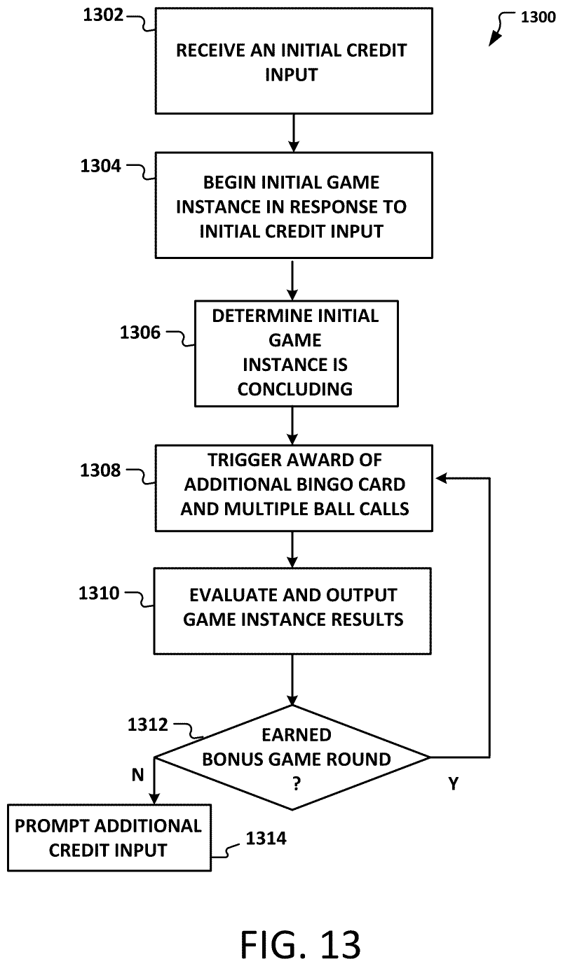

FIG. 13 is a flowchart of an embodiment of a method 1300 of providing an electronic game that includes a set of reels and a backend bingo game configured to award bonus games that are presented using the reels. The illustrative method 1300 may be performed by any of the preceding systems described in FIGS. 1-5 and 8.

Turning more particularly to the flowchart, the embodiment of the method 1300 at step 1302 may receive an initial credit input from a player. For instance, the gaming device 400 of FIG. 4 may receive a credit input 432 at a user interface module 411.

At step 1304, the method 1300 may include initiating a game instance in response to the initial credit input. For example, the game controller 404 of FIG. 4 may trigger a bingo game (such as is shown in FIG. 8) in response to the credit input 432.

Where the game instance is determined to be near or otherwise at its conclusion at step 1306, the illustrative method 1300 may award a bonus bingo card and additional ball calls at 1308. The bonus operation at step 1308 may be triggered without the player having to make a second credit input. The bonus operation of a particular embodiment may be triggered regardless of whether a match has been achieved for the bingo card(s). For example, the method 1300 may include a programmatic trigger that automatically awards additional ball calls and the additional bingo card at step 1308. For instance, the game controller 404 of FIG. 4 may trigger a bonus game operation 419 that awards at least one of a game card (as shown in FIG. 8). Thus, in response to a completion of the game instance, the method 1300 may award a bonus game operation that extends the game instance, still based off of the initial wager made back at step 1302.

The method 1300 may evaluate the awarded ball calls and additional bingo card against all of the bingo card at 1310. In turn, the method may report or otherwise output the results of the evaluation to the player.

The method 1300 may determine at 1312 if a bonus game round has been earned by the player. A bonus game round of an embodiment may be awarded on merit by virtue of an evaluation matching ball call data with patterns on a bingo card. If so, play may continue with another bonus operation at 1308. Otherwise, the system may prompt the user for additional credit input to continue the game session at 1314.

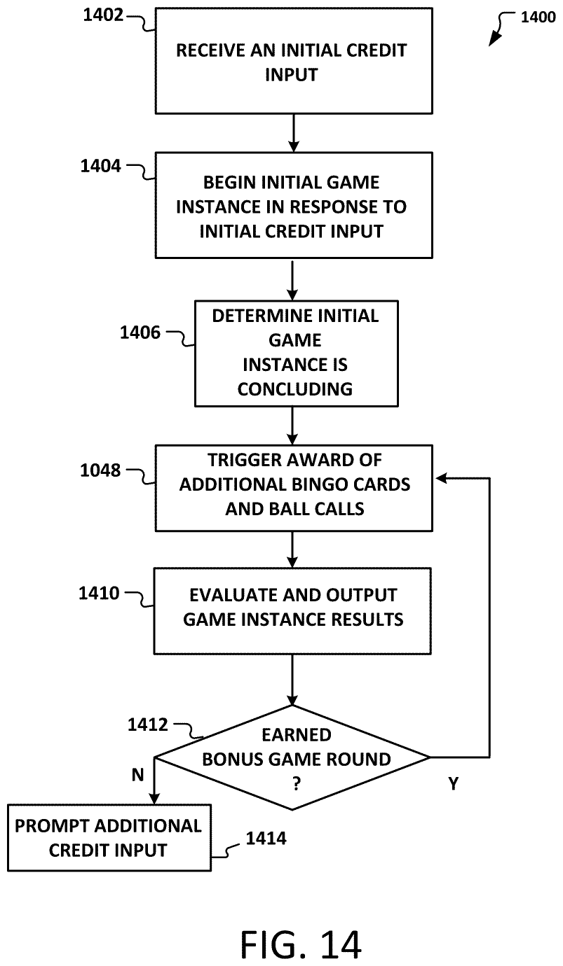

FIG. 14 is a flowchart of an embodiment of a method 1400 of providing an electronic game that includes a set of reels and a backend bingo game configured to award bonus games that are presented using the reels. The illustrative method 1400 may be performed by any of the preceding systems described in FIGS. 1-5 and 9.

Turning more particularly to the flowchart, the embodiment of the method 1400 at step 1402 may receive an initial credit input from a player. For instance, the gaming device 400 of FIG. 4 may receive a credit input 432 at a user interface module 411.

At step 1404, the method 1400 may include initiating a game instance in response to the initial credit input. For example, the game controller 404 of FIG. 4 may trigger a bingo game (such as is shown in FIG. 9) in response to the credit input 432.

Where the game instance is determined to be near or otherwise at its conclusion at step 1406, the illustrative method 1400 may award multiple bonus bingo cards and additional ball calls at 1408. The bonus operation at step 1408 may be triggered without the player having to make a second credit input. The bonus operation of a particular embodiment may be triggered regardless of whether a match has been achieved for the bingo cards. For example, the method 1400 may include a programmatic trigger that automatically awards additional ball calls and additional bingo cards at step 1408. For instance, the game controller 404 of FIG. 4 may trigger a bonus game operation 419 that awards at least one of a game card (as shown in FIG. 9). Thus, in response to a completion of the game instance, the method 1400 may award a bonus game operation that extends the game instance, still based off of the initial wager made back at step 1402.

The method 1400 may evaluate the awarded ball calls and additional bingo card against all of the bingo card at 1410. In turn, the method may report or otherwise output the results of the evaluation to the player.

The method 1300 may determine at 1412 if a bonus game round has been earned by the player. A bonus game round of an embodiment may be awarded on merit by virtue of an evaluation matching ball call data with patterns on a bingo card. If so, play may continue with another bonus operation at 1408. Otherwise, the system may prompt the user for additional credit input to continue the game session at 1414.

In one exemplary embodiment, an electronic gaming device including at least one memory with instructions stored thereon, and at least one processor in communication with the at least one memory is provided. The instructions, when executed by the at least one processor, cause the at least one processor to: in response to receiving a user input, initiate an electronic base game including: randomly provide an electronic bingo card for the base game, provide a base game ball call, determine that at least one winning pattern is included on the base game bingo card by electronically comparing the base game ball call to the base game bingo card and performing a lookup within an award pattern table, cause a reel outcome to be displayed on a set of reels corresponding to the at least one winning pattern; and determine that a feature game is triggered. The processor is further programmed to initiate the feature game by: randomly provide a new electronic bingo card for the feature game, determine that at least one winning pattern is included on the new bingo card by electronically comparing the base game ball call to the new bingo card and performing a lookup within the award pattern table, and cause a new reel outcome to be displayed on the set of reels for the feature game corresponding to the at least one winning pattern of the new bingo card.

In another exemplary embodiment, an electronic gaming device including at least one memory with instructions stored thereon, and at least one processor in communication with the at least one memory is provided. The instructions, when executed by the at least one processor, cause the at least one processor to: in response to receiving a user input, initiate an electronic base game including: randomly provide an electronic bingo card for the base game, provide a base game ball call, determine that at least one winning pattern is included on the base game bingo card by electronically comparing the base game ball call to the base game bingo card and performing a lookup within an award pattern table, cause a reel outcome to be displayed on a set of reels corresponding to the at least one winning pattern. The processor is further programmed to determine that a feature game is triggered, and initiate the feature game by: randomly provide at least one new ball call for the feature game, determine that at least one winning pattern is included on the base game bingo card by electronically comparing the at least one new ball call to the base game bingo card and performing a lookup within the award pattern table, and cause a new reel outcome to be displayed on the set of reels for the feature game corresponding to the at least one winning pattern.

In another exemplary embodiment, an electronic gaming device including at least one memory with instructions stored thereon, and at least one processor in communication with the at least one memory is provided. The instructions, when executed by the at least one processor, cause the at least one processor to: in response to receiving a user input, initiate an electronic base game including: randomly provide an electronic bingo card for the base game, provide a base game ball call, determine that at least one winning pattern is included on the base game bingo card by electronically comparing the base game ball call to the base game bingo card and performing a lookup within an award pattern table, cause a reel outcome to be displayed on a set of reels corresponding to the at least one winning pattern, and determine that a feature game is triggered. The processor is further programmed to initiate the feature game by: randomly provide a new electronic bingo card and at least one new ball call for the feature game, determine that at least one winning pattern is included on the new bingo card or the base bingo card by electronically comparing the base game ball call and the at least one new ball call to the based and new bingo cards, and performing a lookup within the award pattern table, and cause a new reel outcome to be displayed on the set of reels for the feature game corresponding to the at least one winning pattern of the new bingo card.

In another exemplary embodiment, an electronic gaming device including at least one memory with instructions stored thereon, and at least one processor in communication with the at least one memory is provided. The instructions, when executed by the at least one processor, cause the at least one processor to: in response to receiving a user input, initiate an electronic base game including: randomly provide an electronic bingo card for the base game, provide a base game ball call, determine that at least one winning pattern is included on the base game bingo card by electronically comparing the base game ball call to the base game bingo card and performing a lookup within an award pattern table, cause a reel outcome to be displayed on a set of reels corresponding to the at least one winning pattern, and determine that a feature game is triggered. The processor is further programmed to initiate the feature game by: randomly provide multiple new electronic bingo cards and multiple new ball calls for the feature game, determine that at least one winning pattern is included on the base bingo card or the multiple new bingo cards by electronically comparing the base game ball call and the multiple new ball calls to the base bingo card and the multiple new bingo cards, and performing a lookup within the award pattern table, and cause a new reel outcome to be displayed on the set of reels for the feature game corresponding to the at least one winning pattern of the base bingo card and the multiple new bingo cards.

In another exemplary embodiment, a method of providing a game at an electronic gaming device is provided. The method includes in response to receiving a user input, initiating an electronic base game including: randomly providing an electronic bingo card for the base game, providing a base game ball call, determining that at least one winning pattern is included on the base game bingo card by electronically comparing the ball call to the bingo card and performing a lookup within an award pattern table, causing a reel outcome to be displayed on a set of reels corresponding to the at least one winning pattern, and determining that a feature game is triggered. The method further includes initiating the feature game by: randomly providing a new electronic bingo card for the feature game, determining that at least one winning pattern is included on the new bingo card by electronically comparing the ball call from the base game to the new bingo card and performing a lookup within the award pattern table, and causing a new reel outcome to be displayed on the set of reels for the feature game corresponding to the at least one winning pattern of the new bingo card.

In another exemplary embodiment, a non-transitory computer-readable storage medium is provided. The computer-executable instructions that when executed by at least one processor, cause the at least one processor to: in response to receiving a user input, initiate an electronic base game including: randomly provide an electronic bingo card for the base game, provide a base game ball call, determine that at least one winning pattern is included on the base game bingo card by electronically comparing the ball call to the bingo card and performing a lookup within an award pattern table, cause a reel outcome to be displayed on a set of reels corresponding to the at least one winning pattern, and determine that a feature game is triggered. The instructions when further executed initiate the feature game by: randomly provide a new electronic bingo card for the feature game, determine that at least one winning pattern is included on the new bingo card by electronically comparing the ball call from the base game to the new bingo card and performing a lookup within the award pattern table, and cause a new reel outcome to be displayed on the set of reels for the feature game corresponding to the at least one winning pattern of the new bingo card.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory with instructions stored thereon; and
at least one processor in communication with the at least one memory, wherein the instructions, when executed by the at least one processor, cause the at least one processor to:
in response to receiving a user input, determine that at least one winning pattern is included on a base game bingo card by electronically comparing a base game ball call to the base game bingo card;
cause a base game reel outcome to be displayed on a display including a set of reels, the base game reel outcome corresponding to the at least one winning pattern;
determine that a feature game is triggered;
in response to the feature game being triggered, determine that at least one new winning pattern is included (i) on a new bingo card by electronically evaluating the new bingo card using the base game ball call or (ii) on the base game bingo card by electronically evaluating the base game bingo card using a new ball call; and
cause a new reel outcome to be displayed on the display including the set of reels, the new reel outcome corresponding to the at least one new winning pattern.

2. The electronic gaming system of claim 1, wherein the instructions further cause the at least one processor to, in response to receiving the user input, retrieve the base game bingo card and the base game ball call.

3. The electronic gaming system of claim 1, wherein the instructions further cause the at least one processor to, in response to the feature game being triggered, retrieve the new bingo card or the new ball call.

4. The electronic gaming system of claim 1, wherein the at least one winning pattern includes multiple winning patterns.

5. The electronic gaming system of claim 4, wherein the instructions further cause the at least one processor to display an outcome for each winning pattern of the multiple winning patterns.

6. The electronic gaming system of claim 1, wherein the instructions further cause the at least one processor to provide multiple new electronic bingo cards for the feature game.

7. The electronic gaming system of claim 1, wherein the instructions further cause the at least one processor to provide multiple new ball calls for the feature game.

8. The electronic gaming system of claim 1, wherein the new reel outcome includes an overlaid translucent or transparent colored graphic effect on the display.

9. A method of providing a game at an electronic gaming device, the method comprising:
in response to receiving a user input, determining that at least one winning pattern is included on a base game bingo card by electronically comparing a base game ball call to the base game bingo card;
causing a base game reel outcome to be displayed on a display including a set of reels, the base game reel outcome corresponding to the at least one winning pattern;
determining that a feature game is triggered;
in response to the feature game being triggered, determining that at least one new winning pattern is included (i) on a new bingo card by electronically evaluating the new bingo card using the base game ball call or (ii) on the base game bingo card by electronically evaluating the base game bingo card using a new ball call; and
causing a new reel outcome to be displayed on the display including the set of reels for the feature game, the new reel outcome corresponding to the at least one new winning pattern.

10. The method of claim 9, further comprising in response to receiving the user input, retrieving the base game bingo card and the base game ball call.

11. The method of claim 9, further comprising, in response to the feature game being triggered, retrieving the new bingo card or the new ball call.

12. The method of claim 9, wherein the at least one winning pattern includes multiple winning patterns.

13. The method of claim 12, further comprising displaying an outcome for each winning pattern of the multiple winning patterns.

14. The method of claim 9, further comprising providing multiple new electronic bingo cards for the feature game.

15. The method of claim 9, further comprising providing multiple new ball calls for the feature game.

16. The method of claim 9, wherein the new reel outcome includes an overlaid translucent or transparent colored graphic effect on the display.

17. At least one non-transitory computer-readable storage media having computer-executable instructions embodied thereon, wherein when executed by at least one processor, the computer-executable instructions cause the at least one processor to:
in response to receiving a user input, determine that at least one winning pattern is included on a base game bingo card by electronically comparing a base game ball call to the base game bingo card;
cause a base game reel outcome to be displayed on a display including a set of reels, the base game reel outcome corresponding to the at least one winning pattern;
determine that a feature game is triggered;
in response to the feature game being triggered, determine that at least one new winning pattern is included (i) on a new bingo card by electronically evaluating the new bingo card using the base game ball call or (ii) on the base game bingo card by electronically evaluating the base game bingo card using a new ball call; and
cause a new reel outcome to be displayed on the display including the set of reels, the new reel outcome corresponding to the at least one new winning pattern.

18. The at least one non-transitory computer-readable storage media of claim 17, wherein the computer-executable instructions further cause the at least one processor to, in response to receiving the user input, retrieve the base game bingo card and the base game ball call.

19. The at least one non-transitory computer-readable storage media of claim 17, wherein the computer-executable instructions further cause the at least one processor to, in response to the feature game being triggered, retrieve the new bingo card or the new ball call.

20. The at least one non-transitory computer-readable storage media of claim 17, wherein the at least one winning pattern includes multiple winning patterns, and wherein the computer-executable instructions further cause the at least one processor to display an outcome for each winning pattern of the multiple winning patterns.
